(19) United States
(12) Patent Application Publication
(10) Pub. No.: US 2006/0243140 A1
(43) Pub. Date: Nov. 2, 2006

(54) Separating column, especially for a miniaturised gas chromatograph

(76) Inventors: Uwe Lehmann, Hamburg (DE); Oliver Glampe, Bad Schwartau (DE)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 10/539,261

(22) PCT Filed: Jan. 22, 2004
(86) PCT No.: PCT/DE04/00089

§ 371 Date: Nov. 17, 2005

(30) Foreign Application Priority Data
Jan. 27, 2003 (DE) 10303107.3

(51) Int. Cl. G01N 30/02

(52) U.S. Cl. 96/101; 73/23.39; 73/23.35; 210/198.2

(57) ABSTRACT

The invention relates to a separating column, especially for miniaturised gas chromatograph. In addition to a micro-chromatograph provided with one or more inventive separating column. The inventive separating column prevents the known racetrack effect and can therefore be produced in a simple and economical manner. The separating column (1) comprises a channel (2) for a flow of fluid having analysate molecules. The flow of fluid comprises counter flowing curves (3, 4) with turning points (7, 8), the average diameter of the channel (2) is greater than the length of the path traversed by an analysate molecule when diffused between two turning points (7, 7a; 8, 8a).

The present invention relates to a separating column, especially for a miniaturized gas chromatograph. In addition, the present invention also relates to a micro-chromatograph, particularly a gas micro-chromatograph, having one or more separating columns according to the present invention.

The separation efficiency of a chromatography column is also a function of the column length, in addition to other parameters (temperature, pressure, flow velocity, column material, etc.) Typically, the separation efficiency of the column increases with increasing length in this case, since the time of interaction of the sample components to be separated with the stationary phase is lengthened. In miniaturized analysis systems, for example, gas micro-chromatographs, suitable measures must be used in order to be able to implement a column having sufficient and/or optimum length on the small space available. It thus becomes necessary to dispense with a linear shape of the separating channel of the separating column and provide “curved” columns having a spiral or meandering separating channel, for example. A separating column having spiral geometry is known, for example, from DE 19726000.

In such “curved” columns it has been observed that the separation effect is significantly worse than in “classical” linear chromatography columns of comparable length. In particular, widening of the analyte bands and/or the analyte peaks is to be observed. This is attributed to the “racetrack” effect. In a curved section of the separating channel of the separating column, analyte molecules which are on the inside of the channel (an “inside track”), on the channel wall lying in the curved direction, have a comparably shorter path to cover than molecules in the outer edge region (an “outside track”) of the separating channel. Among other things, this results in a geometric defocusing of the analyte package (a region of the fluid stream in which the analyte molecules are enriched), which may be amplified further on the way through the column.

In order to counter this problem, it has been suggested by Culbertson et al., for example, (2000, in: van den Berg et al. (Eds.): Micro Total Analysis Systems 2000, pages 221-224) that a spiral column having the largest possible radius of curvature be used. Naturally, this becomes more difficult the smaller the analysis devices become and the less space is available.

Lagally et al. (2000, in: van den Berg et al. (Eds.): Micro Total Analysis Systems 2000, pages, pages 217-220) suggests conical constructions and/or expansions of the separating channel cross-section before and after a curvature for meandering columns, in order to minimize the “racetrack” effect. A ratio of the channel diameter before a constriction to the constricted channel diameter of 4:1 has been shown to be especially suitable. Such columns having different channel cross-sections are complex to manufacture, however. Furthermore, velocity changes of the analyte molecules and different interaction times with the stationary phase caused by the channel cross-section changes in the separating column are problematic and typically worsen the performance of such separating columns.

Molho et al. (2000, in: van den Berg et al. (Eds.): Micro Total Analysis Systems 2000, pages 287-290) also suggest a constriction of the channel cross-section in the curved region of the separating column, which is shaped in a special way, for meandering columns. Because of the complicated geometry of these columns, their manufacturing is also complex and difficult and has the above-mentioned problems. In addition, the achievement of the object suggested is not suitable for semicircular curves, for example, since zones having very low fluid streams are provided here.

The object of the present invention is therefore to provide a separating column which has a sufficient length at the compactness necessary for micro-chromatographs and avoids the disadvantages of the related art. In particular, it is the object of the present invention to provide a separating column in which the “racetrack” effect described is kept as low as possible and which is nonetheless simple and cost-effective to manufacture.

The object is achieved by the subject matter of claim 1. Advantageous embodiments of the present invention are the subject matter of the subclaims.

The separating column according to the present invention has a channel for a fluid flow having molecules to be analyzed (analyte molecules). The channels may be implemented by structuring trenches in a semiconductor disk, such as a silicon disk, and covering the silicon disk with a second silicon disk or a glass disk, for example. The manufacturing of such a channel structure is described, for example, in DE 19726000. The channel has opposing curves having turning points at which the curve direction preferably changes alternately. In this way, the channel receives a meandering geometry. A turning point as defined in the present invention as a point at which the curved direction of the channel and therefore also the flow direction of the fluid stream flowing through the channel changes to the particular other direction. A fluid stream as defined in the present invention is any gas or liquid stream. A curve as defined in the present invention is understood as any curved region of the channel having the same curve direction. Such a curve lies between two directly sequential turning points, which mark a change to the particular other direction. In the separating column according to the present invention, the mean diameter of the channel is larger than the path which an analyte molecule covers through diffusion on its way between two sequential turning points that mark an identical direction change. These are to be understood as turning points which are located at the beginning of a curve having the same curve direction.

There is an essentially laminar flow in a separating column channel. The present invention is now based on the surprising recognition that the “racetrack” effect described above may be avoided if the column geometry is designed so that an analyte molecule on the inside of the curve (the “inside track”) is prevented from being able to reach the diametrically opposite side (the “outside track”) of the separating column channel through diffusion on the way from one turning point to the next turning point having identical direction change. For this purpose, in the separating column according to the present invention, the channel diameter and/or cross-section is made larger than the diffusion path which an analyte molecule must cover on the way between two sequential turning points that mark the same direction change. In this way, the analyte molecules remain essentially on their track and do not change between “inside track” and “outside track” in a way which results in a strong defocusing of the analyte package.

A measure for the path which is covered by an analyte molecule in the time that passes during the transport in the fluid stream between two such turning points is the diffusion length x₀:
x₀=2√Dt

In this case, D is the diffusion coefficient, and t is time. D is a function of the temperature, the pressure, and the type of molecule, among other things. If the parameters which influence the diffusion coefficient D are kept constant, the diffusion length may be determined easily.

In a preferred embodiment of the present invention, the mean diameter of the channel is at least one order of magnitude, i.e., ten times, larger than the path which an analyte molecule covers through diffusion on its way between two sequential turning points having identical direction change. Defocusing of the analyte package through the racetrack effect is thus largely avoided.

In a preferred embodiment, the number of turning points which mark the beginning of curves having a specific curve direction is equal to the number of turning points which indicate the beginning of curves having the opposite curve direction. A complete compensation of the direction changes which the fluid stream performs on its way from the start of the separating column to its end thus occurs, so that the racetrack effect may be effectively minimized or prevented. Defocusing of the analyte package may be countered in this way.

In a further preferred embodiment, the separating column has at least one loop, which in turn has legs on which the curves described are provided. The meandering separating column channel forms a higher-order meander structure in this way. This results in an especially compact separating column geometry, so that an optimum space savings is possible for a predefined column length.

The curves preferably follow one another directly and are not separated by linear sections. However, it is also possible in a column according to the present invention to provide linear sections. These are preferably to be positioned so that a complete compensation of the direction changes has occurred before the linear section. Otherwise, the danger arises that the analyte molecules which are on the edge region (inner or outer) of the curve, for example, will move to the particular other side through diffusion on the way along the linear section and thus cause defocusing of the analyte package.

The legs of the loops of the separating column are preferably positioned parallel to one another. Such a geometry is simpler to manufacture than an angled arrangement, for example. Curves having a specific curve direction on one leg especially preferably lie diametrically opposite the curves having the identical curve direction on the neighboring leg, so that the curves lie on a shared line, which is perpendicular to an axis drawn in the longitudinal direction through the leg. Through this arrangement, the possibility arises of positioning the two legs of a loop close to one another, so that an especially compact structure results. In addition, this embodiment is especially favorable for manufacturing.

In another embodiment of the present invention, the curves having one curve direction on one leg lie diametrically opposite each of the curves having the opposite curve direction on the neighboring leg.

In a further preferred embodiment of the present invention, the legs are connected to one another by linear sections. This is the simplest solution to manufacture. These linear sections are preferably positioned in such way that a complete compensation of the direction changes through alternating curves which compensate for one another has occurred before the linear section. Instead of the linear sections described, however, the legs may be connected to one another by further curves. In this way, an even further extension of the separating column may be achieved.

The separating column according to the present invention may also especially advantageously be housed multiple times on a chip, such as a semiconductor chip (e.g., a silicon chip), so that possibly multiple analyses may be performed in parallel—even for different components to be analyzed. Multiple separating columns according to the present invention may also be connected one behind another on a chip, without relevant worsening of the measurement results to be feared therefrom.

The separating column according to the present invention is especially advantageously provided with a stationary phase, as is described in DE 19726000. Equipping the separating column according to the present invention with such a homogeneous stationary phase is especially desirable in order to further improve the separation efficiency. The use of different stationary phases having different thicknesses, chemical and/or physical properties, etc., for example, is thus also made significantly easier, particularly if multiple separating columns are connected in parallel and/or in series on a semiconductor chip.

The present invention also relates to a micro-chromatograph, particularly a gas micro-chromatograph, having one or more separating columns according to the present invention. The micro-chromatograph has at least one separating column according to the present invention. However, the micro-chromatograph may also be equipped with more than one separating column. The separating columns are preferably housed in this case on a shared chip, such as a semiconductor chip, a silicon wafer, or the like.

In a preferred embodiment of the micro-chromatograph, the separating columns are each provided with different stationary phases. The stationary phases differ in this case in their chemical and/or physical properties, for example, in their thickness, their composition, their interaction properties with analyte molecules, etc. The use of stationary phases as described in DE 19726000 is especially advantageous.

In an especially preferred embodiment of the micro-chromatograph, the separating columns on the chip may, for example, be connected to one another in series and/or in parallel. For a serial connection, at least two separating columns according to the present invention are positioned one behind another, so that a fluid stream flows through the separating columns sequentially. For a parallel connection, at least two separating columns are positioned in such way that separate fluid streams flow through them. This may also be a fluid stream which was divided before the separating columns connected in parallel. Serial and parallel column connection may also be combined on a chip and/or wafer. Such micro-chromatographs are interesting particularly because simultaneous parallel measurements of the same sample component(s) and/or simultaneous measurements of different sample components are possible with their aid. Through the use of the separating column according to the present invention, the provision of such a multiple measuring device is possible, without significant reductions in the quality of the measurement, particularly the separation efficiency, having to be accepted.

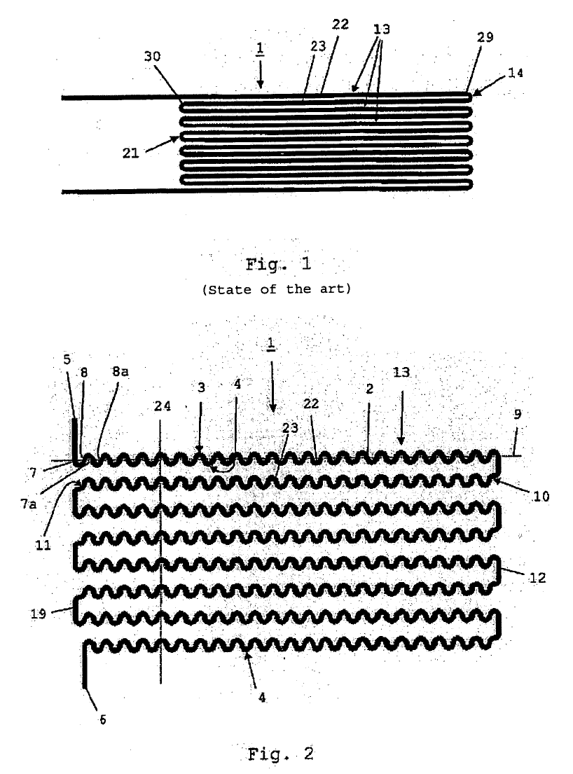

In the following, the present invention will be explained in greater detail on the basis of FIGS. 1 through 4.

FIG. 1 shows a top view of a separating column according to the related art.

FIG. 2 shows a top view of an embodiment of the present invention.

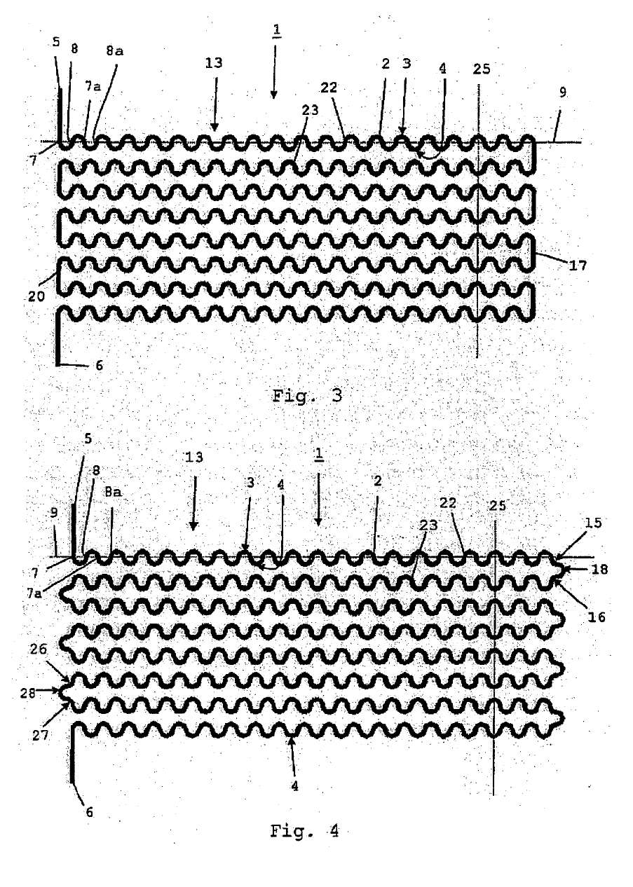

FIG. 3 shows a top view of a second embodiment of the present invention.

FIG. 4 shows a top view of a further embodiment of the present invention.

FIG. 1 schematically shows a separating column for a micro-chromatograph known from the related art. The separating column 1 has loops 13 having legs 22, 23, so that a meandering structure results. Long linear sections are located between the curves 14, 21. In this column geometry, the analyte molecules are defocused through the “racetrack” effect as they pass through the curves 14, 21, without a corresponding compensation occurring. Through diffusion, the analyte molecules distribute themselves randomly over the channel cross-section on the linear section between two curves 14, 21, so that an analyte molecule which lay on an “inside track” in the preceding curve 14, 21, for example, may travel to the other side of the channel up until it passes through the following curve 14, 21, so that it again moves on an “inside track” here. Because the channel cross-section and/or diameter is smaller than the path which the analyte molecule covers through diffusion on its way between two turning points 29, 30, defocusing of the analyte package occurs. For such a separating column according to the related art, this effect has been proven particularly clearly by Molho et al. (2000, in: van den Berg et al. (Eds.): Micro Total Analysis Systems 2000, pages 287-290).

FIG. 2 shows a preferred embodiment of the present invention. The separating column 1 forms loops 13 (four here) having legs 22, 23 between the inlet 5 and outlet 6 of the separating column 1. The channel 2, which is structured in a silicon disk (a silicon wafer) with the aid of standard methods of microsystem technology, such as lithographic methods, has a meandering shape. This arises through sequential curves 3, 4. The curves 3 have a curve direction which is opposite to that of the curves 4. If one assumes a flow direction of the fluid stream from the separating column inlet 5 to the separating column outlet 6, the curves 3 have a clockwise curvature in the top view, while the curves 4 display a counterclockwise curvature. Turning points 7, 7a and/or 8, 8a lie at points having a change of the curve direction. These turning points lie on an imaginary longitudinal axis 9 drawn through a leg 22, 23. The curves 3, 4 follow one another directly, without a linear section between them. Because the mean diameter of the channel 2 is larger than the path which an analyte molecule covers through diffusion on its way between two turning points (7, 7a; 8, 8a), defocusing of the analyte package is largely avoided. The number of curves 3 preferably corresponds to the number of opposing curves 4, so that a compensation of the direction changes occurs. In the embodiment shown, the curves 3 lie directly one on top of another on an imaginary line 24 perpendicular to the longitudinal axis 9 in a top view. Correspondingly, the curves 4 also lie directly on top of one another. The legs 22, 23 running parallel to one another may thus be positioned close to one another. The legs 22 are connected to the particular neighboring legs 23 via linear channel sections 12, 19 and curves 10, 11. In contrast to the curves 3, 4, the curves 10, 11 do not describe a semicircle, but rather only a quarter circle, i.e., an angle of approximately 90°. The direction changes are also largely compensated for here. In addition, it is unimportant for the separation efficiency of the separating column 1 according to the present invention if individual curves 3, 4, 10, 11 toward the inlet 5 and/or outlet 6 of the separating column 1 do not experience a corresponding compensation. The linear sections 12, 19 are positioned at points at which a complete compensation of the direction changes has occurred, so that the effect described here for the column in FIG. 1 may not occur. After entering the column at the inlet 5, the fluid stream reaches the first turning point 7, which marks the beginning of the first curve 4. A counterclockwise direction changes occurs there. After passing through the curve 4, the fluid stream reaches the first turning point 8, which marks the beginning of the first curve 3, where a clockwise direction change occurs. The direction change caused by the first curve 4 is compensated for after passing through the first curve 3. After passing through the first curve 3, the fluid stream reaches the turning point 7a, at which a counterclockwise direction change also occurs. At the turning point 8a, a clockwise correction change occurs again, etc. After passing through the leg 22 of the first loop 13, the fluid stream passes through a first linear section 12 and a first curve 10, passes through the leg 23 in a direction which is opposite to that through the leg 22, and enters the leg 22 of the second loop 13 via a first curve 11 and a first linear section 19. After passing through the second loop 13 and two further loops 13, the fluid stream exits out of the outlet 6 of the column and reaches either a downstream separating column 1 and/or a detector here.

FIGS. 3 and 4 show two further preferred embodiments of the present invention. In contrast to the separating column 1 shown in FIG. 2, the curves 3, 4 on neighboring legs 22, 23 do not lie one directly on top of another, but rather are offset in such a way that a curve 3 lies over a curve 4 and/or neighbors it in each case on an imaginary line 25 perpendicular to the axis 9. In the embodiment shown in FIG. 3, the legs 22, 23 are connected to one another by linear sections 17, 20, while in the embodiment shown in FIG. 4, the legs 22, 23 are connected by curves 15, 18, 16 and/or 26, 28, 27, so that a cloverleaf structure results. The curves 18, 28 have an essentially semicircular shape in this case, while the curves 15, 16, 26, 27 merely essentially describe a quarter circle. In both embodiments, the direction changes which occurred are completely compensated for.

### LIST OF REFERENCE NUMBERS

1. separating column
2. channel
3. curve
4. curve
5. separating column inlet
6. separating column outlet
7. turning point
8. turning point
9. axis
10. curve
11. curve
12. section
13. loop
14. curve
15. curve
16. curve
17. section
18. curve
19. section
20. section
21. curve
22. leg
23. leg
24. line
25. line
26. curve
27. curve
28. curve
29. turning point
30. turning point

1. A separating column, particularly for a miniaturized gas chromatograph, having a channel (2) for a fluid stream having molecules to be analyzed (analyte molecules), the channel (2) having opposing curves (3, 4) having turning points (7, 8), characterized in that the mean diameter of the channel (2) is greater than the path which an analyte molecule covers through diffusion on its way between two turning points (7, 7a; 8, 8a).

2. The separating column according to claim 1, characterized in that the mean diameter of the channel (2) is at least ten times greater than the path which an analyte molecule covers through diffusion on its way between two turning points (7, 7a; 8, 8a).

3. The separating column according to claim 1, characterized in that the number of the turning points (7, 7a) is equal to the number of the turning points (8, 8a).

4. The separating column according to claim 1, characterized in that the separating column (1) has at least one loop (13) on whose legs (22, 23) the curves (3, 4) are provided.

5. The separating column according to claim 1, characterized in that the curves (3, 4) follow one another directly.

6. The separating column according to claim 4, characterized in that the legs (22, 23) run essentially parallel.

7. The separating column according to claim 6, characterized in that the curves (3) on the legs (22, 23) are diametrically opposite one another, so that the curves (3) lie on a shared line (24) perpendicular to an axis (9) drawn through the leg (22) in the longitudinal direction.

8. The separating column according to claim 6, characterized in that the curves (3) on the leg (22) each lie diametrically opposite the curves (4) on the neighboring leg (23).

9. The separating column according to claim 1, characterized in that the having legs (22, 23) that are connected by linear sections (12, 19, 17, 20).

10. The separating column according to claim 6, having legs (22, 23) that are connected to one another by curves (15, 18, 16, 26, 27, 28).

11. A micro-chromatograph, particularly a gas micro-chromatograph, characterized in that the micro-chromatograph has at least one separating column having a channel (2) for a fluid stream having molecules to be analyzed (analyte molecules), the channel (2) having opposing curves (3, 4) having turning points (7, 8), characterized in that the mean diameter of the channel (2) is greater than the path which an analyte molecule covers through diffusion on its way between two turning points (7, 7a; 8, 8a).

12. The micro-chromatograph according to claim 11, characterized in that the micro-chromatograph has multiple separating columns (1) on a shared semiconductor chip.

13. The micro-chromatograph according to claim 12, characterized in that the separating columns (1) are each provided with stationary phases which have different chemical and/or physical properties.

14. The micro-chromatograph according to claim 12, characterized in that the separating columns (1) on the chip are connected to one another in series and/or in parallel.

15. The separating column according to claim 5, characterized in that the legs (22, 23) run essentially parallel.

16. The separating column according to claim 15, characterized in that the curves (3) on the legs (22, 23) are diametrically opposite one another, so that the curves (3) lie on a shared line (24) perpendicular to an axis (9) drawn through the leg (22) in the longitudinal direction.

17. The separating column according to claim 15, characterized in that the curves (3) on the leg (22) each lie diametrically opposite the curves (4) on the neighboring leg (23).

18. The micro-chromatograph, according to claim 12, wherein said semiconductor chip is a silicon chip.
